(19) United States
(12) Patent Application Publication
(10) Pub. No.: US 2015/0234911 A1
(43) Pub. Date: Aug. 20, 2015

(54) SYSTEM AND METHOD FOR LEAVING AND RETRIEVING SOCIAL TRACES

(71) Applicant: CONDUIT LTD., Ness Ziona, IL (US)

(72) Inventors: Eitan Lev, Even Yehuda (IL); Mordechai Teicher, Hod Hasharon (IL)

(21) Appl. No.: 14/182,148

(22) Filed: Feb. 17, 2014

(51) Int. Cl. G06F 17/30; H04L 29/08

(52) U.S. Cl. CPC G06F 17/30598; H04L 67/141; G06F 17/30386; G06F 17/30312

(57) ABSTRACT

Methods and applications (apps) for capturing, storing, retrieving and presenting social traces, which are records of previous visits of friends and contacts of a user to specific locations. Both physical (geographical) and virtual (network) locations are supported. A user at a location may indicate that he or she would like to learn more about the location from a friend or acquaintance listed in the contact list of his or her personal computing device who has previously visited the location. At the user's request, a query is sent out to persons in the contact list, who are prompted to respond if the location appears in a log of their visited locations. A person who responds affirmatively will be automatically connected in a communication session with the inquiring user. Personal privacy is assured, because location and visitation records are kept under control of each user, and no information is sent out without explicit approval by the user.

### BACKGROUND

1. Field

The present invention relates to social networking, and, in particular to sharing experiences at locations among friends.

2. Description of Related Art

Users of computing devices are offered services that notify them when a friend happens to be in their vicinity. Users of social networks post messages and read messages of other friends that share experiences at selected locations. Thus, knowing that a friend has been at, or is currently at, a certain location may provide a user with a meeting opportunity, conversation topic, and/or useful information and tips.

Currently, services as described above suffer from at least the following drawbacks:
for many users, unplanned or coincidental meetings with friends at their current location rarely happen, thus discouraging the installation and use of the service;
automatically sharing one's location with others may compromise privacy; and
receiving a large number of notifications relating to personal experiences at locations may become burdensome to the user, and it may be difficult for a user to recall a notification when it would be relevant.

Embodiments of the present invention overcome the drawbacks described above and offer additional advantages, as described herein.

### SUMMARY

Various embodiments of the present invention provide systems and methods for leaving and retrieving social traces in locations in a convenient manner, while preserving the privacy of all parties involved.

### Location

The term “location” herein denotes both a physical/geographical position and a virtual network address/domain/URL (on the World Wide Web) of the Internet. According to various embodiments of the present invention, a location has one or more unique “location identifiers”, any one of which may be used to identify the location. In a non-limiting example, a user with a mobile telephone (a non-limiting example of a user personal computing device) may be at a geographical location with a location identifier expressed as the geographical address “Rittenhouse Square, Philadelphia, Pa., USA”, or an equivalent location identifier expressed as the geographical coordinates “39.949261° N, 75.172197° W” in the Universal Transverse Mercator (UTM) coordinate system. In another non-limiting example, a user with a desktop computer (another non-limiting example of a user personal computing device) may be at a virtual location with a location identifier expressed as the Uniform Resource Locator (URL) “http://www.jpost.com”, or an equivalent location identifier expressed as the IP address “192.114.68.54”.

In the context of comparing one physical location to another, the term “the same” herein denotes a relation that includes the possibility of physical proximity. According to various embodiments of the invention, two physical locations are considered to be “the same” if their geographical coordinates correspond to the same geographical feature, such as when utilized to determine a proximate physical or geographical feature according to known reverse geocoding techniques.

### Definitions

The term “social trace” herein denotes an indication, to a user at a location, that a friend or acquaintance has previously been at that location. Detecting a social trace in a location may motivate persons present and previous at that location with the party that left the trace, in order to exchange experiences and advice. An exemplary data structure of a social trace according to certain embodiments of the invention is described below.

In certain embodiments of the invention, a user's device is considered to be a proxy for the user regarding being at locations. That is, if a user's device has been classified as having been at a location, the user himself or herself is considered to have been at that location. In a related embodiment, a location also has a set of user device identifiers, each of which identifies a device of a user who has been at the location with the device (for physical locations) or via the device (for virtual locations). For purposes of illustration, therefore, a user device may be illustrated herein as being associated with the user.

According to embodiments of the present invention, the term “being at”, along with its related grammatically-inflected forms, herein denotes both: (a) physically being at or in proximity to a geographical or physical location; and (b) being connected via the Internet to a virtual location.

In human subjective terms, “visiting” a location generally denotes being at the location and having some memorable experience there. However, according to various specific embodiments of the invention, “visiting” a location, as opposed to merely being at the location, is an objective quality that may be automatically distinguished from merely being at the location by a device employing measurable “visitation criteria”. In related embodiments of the invention, visitation criteria apply to both physical locations and virtual locations, and include, but are not limited to:
remaining for at least a predetermined positive period of time at the location;
taking at least a predetermined positive number of photographs, videos, or screen-shots at the location;
requesting content or data (including video and/or audio streaming content and downloads) from the location;
uploading content or data (including a posting) to the location;
making a purchase and/or utilizing a service at the location;
purchasing at least a predetermined positive number of items at the location;
spending at least a predetermined positive amount of money at the location;
attending a meeting or conference at the location;
performing work at the location;
participating in, or being at an event at the location;
obtaining food, refreshment, lodging, entertainment, and/or recreation at the location; and
encountering and/or making friends and/or acquaintances at the location.

The term “current location” herein denotes a location where a user device is at the present time. According to certain embodiments, if it is automatically detected by a user device, that the device being at the location meets one or more objective criteria (such as those presented above), then the current location is automatically classified by the device as a visited location, i.e., a location visited by the user of the device, because the device is considered as a proxy for the user.

The term “database” herein denotes any machine-accessible and machine-readable data or collection thereof. Although not required, a database may have an associated data structure, or “schema”, which defines the organization of the data.

The term “personal computing device” herein denotes any data processing device or apparatus usable by an individual for personal matters, including but not limited to: desktop, notebook, and laptop personal computers; workstations; mobile devices, such as portable telephonic devices, smartphones, tablet computers, and the like. In certain illustrations and descriptions as disclosed herein, mobile user personal computing devices are featured, it being understood that these are non-limiting examples for purposes of illustration only.

According to various embodiments of the present invention, it is not necessary that the user manually “check in” via some kind of separate or dedicated user input into a device or system at the current location in order for the current location to be recognized, or, as specified for certain embodiments, to be considered a visited location. In related embodiments, a manual user check-in operation is also not sufficient for a location to be considered a visited location. In these embodiments, at least one of the visitation criteria for automatic recognition (above) must be met for the current location to be considered a visited location.

Embodiments of the present invention provide methods and systems that allow a user to automatically create a social trace for a location where the user has been. It is noted that creating a social trace does not leave any physical record at the location itself, but instead stores a data record indicating that the user device was at the location. The data record is kept in a data storage accessible by the user device. According to a related embodiment, the social trace is revealed only to user-selected friends or acquaintances, to whom the record of the user's being at the location is displayed on their respective user devices. In certain embodiments, privacy is attained by recording the locations where the user has been within a storage device accessible only by the user, such as a storage device within the user's own personal computing device, or a cloud storage device accessible only by the user's personal computing devices. In related embodiments, privacy is further enhanced by selectively sharing location information only upon specific user approval. The term “cloud storage” herein denotes remote storage in devices accessible via a network. In certain embodiments of the invention, cloud storage devices provide security, such as via encryption, to protect the data stored therein by allowing access only to authorized devices.

There is thus provided, in accordance with an embodiment of the present invention, a method for leaving social traces by personal computing devices, the method including: (a) storing in a data storage, by a first personal computing device, a plurality of stored locations, wherein each stored location is stored upon being a current location of the first personal computing device; (b) receiving, in the first personal computing device, a query from a second personal computing device of a second user, the query identifying at least the second user and a queried location; (c) responsively to the receiving the query: recognizing, by the first personal computing device, the queried location as being the same as one of the plurality of stored locations; (d) responsively to the recognizing: presenting to the first user, by the first personal computing device, a suggestion to communicate with the second user regarding the queried location; and (e) responsively to receiving a user approval of the suggestion: initiating, by the first personal computing device, a communication session between the first personal computing device and the second personal computing device.

In addition, there is also provided in accordance with an embodiment of the present invention, a personal computing device for a user, the personal computing device including: (a) a processor; (b) a user interface; and (c) a non-transitory storage containing a set of executable instructions for the processor, wherein the executable instructions, when executed by the processor, cause the personal computing device to perform: (1) storing in a data storage a plurality of stored locations, wherein each stored location is stored upon being a current location of the personal computing device; (2) receiving, in the personal computing device, a query from a different personal computing device of a different user, the query identifying at least the different user and a queried location; (3) responsively to the receiving the query: recognizing, by the personal computing device, the queried location as being the same as one of the plurality of stored locations; (4) responsively to the recognizing: presenting to the user, via the user interface, a suggestion to communicate with the different user regarding the queried location; and (5) responsively to receiving a user approval of the suggestion: initiating, by the personal computing device, a communication session between the personal computing device and the different personal computing device.

Furthermore, there is provided according to an embodiment of the present invention an app including a set of executable instructions in a non-transitory storage, wherein the executable instructions of the app, when executed by a processor of a personal computing device of a user, cause the personal computing device to perform: (a) storing in a data storage a plurality of stored locations, wherein each stored location is stored upon being a current location of the personal computing device; (b) receiving, in the personal computing device, a query from a different personal computing device of a different user, the query identifying at least the different user and a queried location; (c) responsively to the receiving the query: recognizing, by the personal computing device, the queried location as being the same as one of the plurality of stored locations; (d) responsively to the recognizing: presenting to the user, via the user interface, a suggestion to communicate with the different user regarding the queried location; and (e) responsively to receiving a user approval of the suggestion: initiating, by the personal computing device, a communication session between the personal computing device and the different personal computing device.

### BRIEF DESCRIPTION OF THE DRAWINGS

The present invention will be understood and appreciated more fully from the following detailed description, taken in conjunction with the drawings in which:

FIG. 1A conceptually illustrates a data structure for recording visited locations in a storage unit of a user device, according to an embodiment of the present invention.

FIG. 1B conceptually illustrates a data structure for a visited location, as included in the data structure of FIG. 1A, according to an embodiment of the present invention.

FIG. 1C conceptually illustrates a data structure for visits to a visited location, as included in the data structure of FIG. 1B, according to an embodiment of the present invention.

FIG. 2A conceptually illustrates a user and device environment for handling social traces in physical (geographical) locations according to an embodiment of the present invention.

FIG. 2B conceptually illustrates a user and device environment for handling social traces in virtual (network) locations according to an embodiment of the present invention.

FIG. 3A is a flowchart of a portion of a method, according to an embodiment of the present invention.

FIG. 3B is a flowchart of another portion of the method of FIG. 3A, according to a related embodiment of the present invention.

FIG. 3C is a flowchart of an additional portion of the method of FIG. 3A, according to a related embodiment of the present invention.

FIG. 3D is a flowchart of a further portion of the method of FIG. 3A, according to a related embodiment of the present invention.

FIG. 4A illustrates an exemplary notification and request for user input, according to an embodiment of the present invention.

FIG. 4B illustrates another exemplary notification and request for user input, according to a related embodiment of the present invention.

FIG. 5 is a block diagram which conceptually illustrates an application (“app”) installed in a user personal computing device according to an embodiment of the present invention.

### DETAILED DESCRIPTION

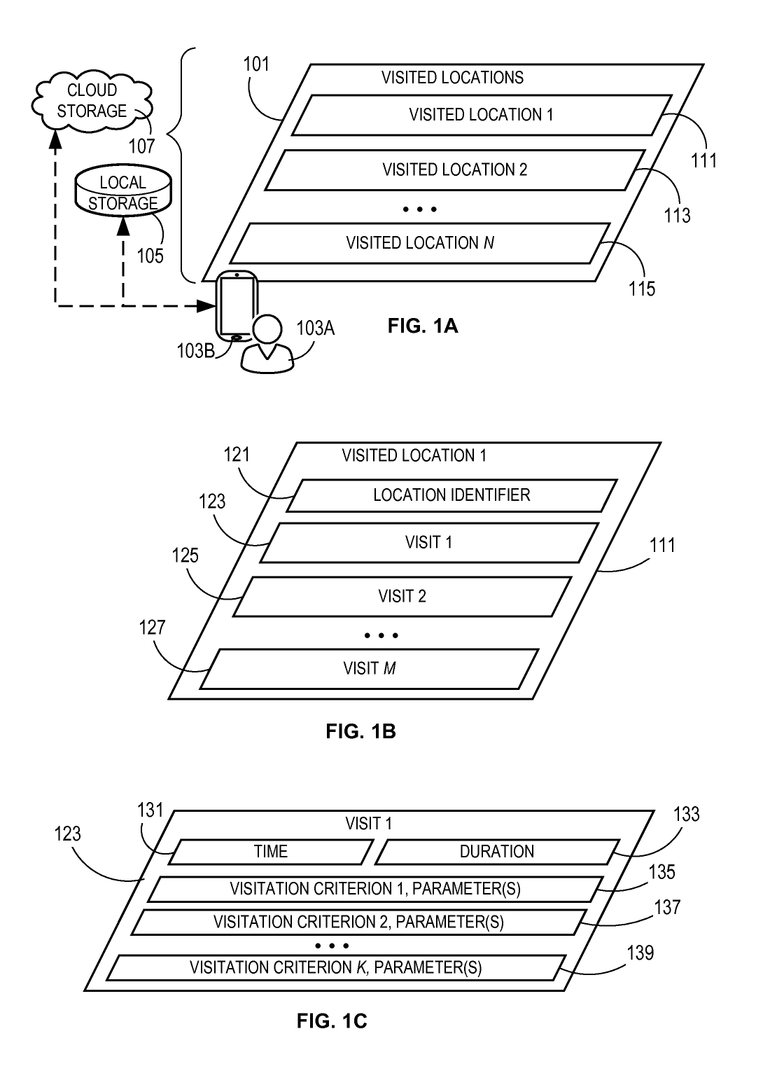

Reference is made to FIG. 1A, which illustrates a data structure 101 for a database of locations visited by a user 103A with a personal computing device 103B, as stored in a non-transitory storage unit 105 or 107 accessible by personal computing device 103B, according to an embodiment of the invention. In a non-limiting example for illustrative purposes, visited locations 101 includes a visited location record 111, a visited location record 113, . . . , and a visited location record 115, respectively relating to a first visited location, a second visited location, . . . , and an Nth visited location. A visited location record contains information about a location itself, for example, its geographical coordinates (for a physical location) or its network address (for a virtual location), and descriptive text that identifies the location in easy-to-recognize terms (e.g., “the Grand Canyon”, “ABC Booksellers” website); and a list of visits to the location by user 103A. More detail about the structure of a visited location record is presented in FIG. 1B, and is discussed below. In certain embodiments of the invention, visited location record data is stored in a local storage device 105 of user personal computing device 103B. In related embodiments, this record data is stored in a secure cloud storage 107.

FIG. 1B illustrates a data structure of visited location record 111 according to the above embodiment of the invention, containing a location identifier 121; and in a non-limiting example for illustrative purposes, visited location record 111 includes visit records 123, 125, . . . , and 127, respectively relating to a first visit, a second visit, . . . , and an Mth visit. A visit record contains information about a specific visit of user 103A to the location, including the time of the visit, the duration of the visit, and which objective visitation criterion or criteria were satisfied to classify being at the location as a visit. More detail about the structure of a visit record is presented in FIG. 1C, and is discussed below. In certain embodiments of the invention, visit record data is stored in local storage device 105 of user personal computing device 103B. In related embodiments, this record data is stored in secure cloud storage 107.

FIG. 1C illustrates a data structure of visit record 123, containing a time 131, according to the above embodiment. In a related embodiment, a time duration 133 is also included; and in a non-limiting example for illustrative purposes, visit record 123 includes visitation criterion and parameter records 135, 137, . . . , and 139, respectively relating to a first visitation criterion and parameter(s), a second visitation criterion and parameter(s), . . . , and a Kth visitation criterion and parameter(s). A visitation criterion and parameter(s) record includes an identifier of the visitation criterion that is satisfied in order for being at location identifier 121 (FIG. 1B) to be considered a visit to that location, along with the parameters of qualification. In a non-limiting example, a user spends 45 minutes browsing the “ABC Booksellers” website and purchases a book for $75, thereby satisfying several criteria, each of which qualify being at this virtual location to be considered a visit. In this example, one visitation criterion and parameter record would contain the information “remained at least 30 minutes (45 minutes)”; another visitation criterion and parameter record would contain the information “purchased at least 1 item (book Last Order of the Lost Cause)”; a third visitation criterion and parameter record would contain the information “spent at least $50 ($75)”. The specific nature and number of parameters depend on the particular visitation criterion that is satisfied. In certain embodiments of the invention, visitation criterion and parameter(s) record data is stored in local storage device 105 of user personal computing device 103B. In related embodiments, this record data is stored in secure cloud storage 107.

The above information about locations and visits is useful in jogging a user's memory of a visit by describing not only where and when the user had been, but how long he or she stayed at the location and the particulars of what he or she did at the location that would distinguish a visit from merely being at the location. Thus, in a related embodiment of the invention, the details are presented to the user along with a query about that location from another user.

### Physical Locations

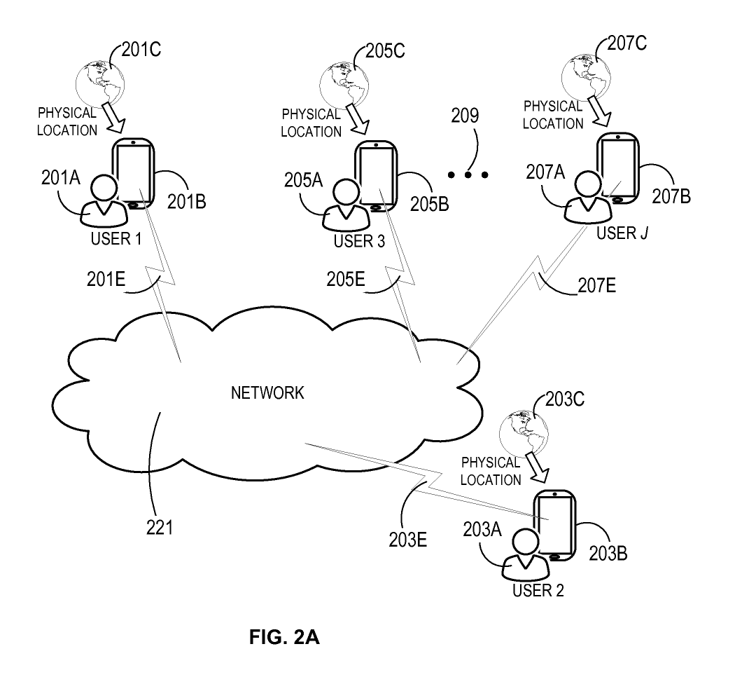

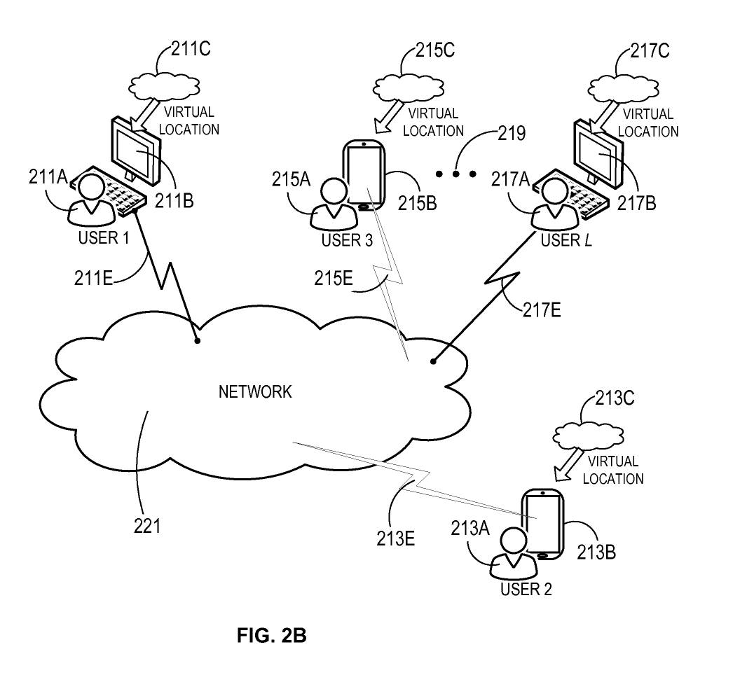

FIG. 2A conceptually illustrates a user and device environment for handling social traces in physical (geographical) locations, according to an embodiment of the present invention. A first user 201A has a first mobile personal computing device 201B, which connects via a wireless link 201E to a network 221. Personal computing device 201B has a physical (e.g., geographical) location 201C. A second user 203A has a second mobile personal computing device 203B, which connects via a wireless link 203E to network 221. Personal computing device 203B has a physical location 203C. A third user 205A has a third mobile personal computing device 205B, which connects via a wireless link 205E to network 221. Personal computing device 205B has a physical location 205C. A Jth user 207A has a Jth mobile personal computing device 207B, which connects via a wireless link 207E to network 221. Personal computing device 207B has a physical location 207D. Mobile personal computing devices 201B, 203B, 205B, and 207B are each equipped with a physical location sensor, such as a GPS receiver, for determining physical location as the devices are moved from one physical location to another on an on-going basis. Ellipsis 209 indicates that additional users and their mobile personal computing devices are possible for the configuration of FIG. 2A.

As discussed above, the concept of physical location includes the notion of proximity, so that two physical locations are considered to be “the same” if their geographical coordinates correspond to the same geographical feature, such as when utilized to determine a proximate physical or geographical feature according to known reverse geocoding techniques.

### Virtual Locations

FIG. 2B conceptually illustrates an exemplary user and device environment for handling social traces in physical (geographical) locations, according to an embodiment of the present invention. A first user 211A has a first (stationary) personal computing device 211B, which connects via a link 211E to a network 221. Personal computing device 211B has a virtual location 211C. A second user 213A has a second personal computing device 213B, which connects via a link 213E to network 221. Personal computing device 213B has a physical virtual 203C. A third user 215A has a third personal computing device 215B, which connects via a link 215E to network 221. Personal computing device 215B has a virtual location 215C. An Lth user 217A has an Lth personal computing device 217B, which connects via a link 217E to network 221. Personal computing device 217B has a virtual location 217D. In this non-limiting example, personal computing devices 211B and 217B are stationary personal computing devices.

The term “stationary” in the context of personal computing devices herein denotes a device which is not equipped with a physical location sensor, such as a GPS receiver. According to various embodiments of the invention, a stationary personal computing device is not necessarily capable of determining its physical location, and therefore a physical (e.g., geographical) location is not necessarily defined for a stationary device. Ellipsis 219 indicates that additional users and their personal computing devices are possible for the configuration of FIG. 2B.

According to an embodiment of the invention, virtual locations may easily be specified exactly, such as via a URL or IP address, and therefore the concept of “proximity” is not needed in a virtual context. In this embodiment, two virtual locations are considered to be “the same” only if they correspond to the exact same network location.

### Generalized Locations

In the environments illustrated in FIG. 2A and 2B, according to various embodiments of the invention, a personal computing device is considered to be a proxy for the user regarding location. That is, the physical or virtual location of the personal computing device is considered to be that of the user; with regard to locations and visitations, the locations and visits of a personal computing device are considered to be interchangeable with those of the user. In a non-limiting example of an embodiment of the invention, a stored log of the locations and visits of a personal computing device is considered to be a log of the locations and visits of the user of the personal computing device. In another non-limiting example of the invention, the current location (physical or virtual) of a personal computing device is considered to be equivalent to the current location (physical or virtual) of the user.

### Methods

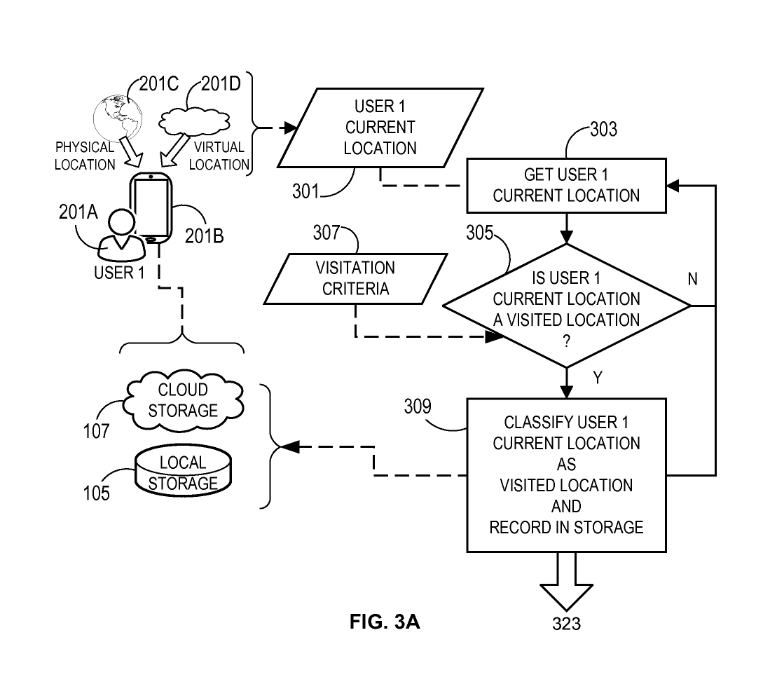

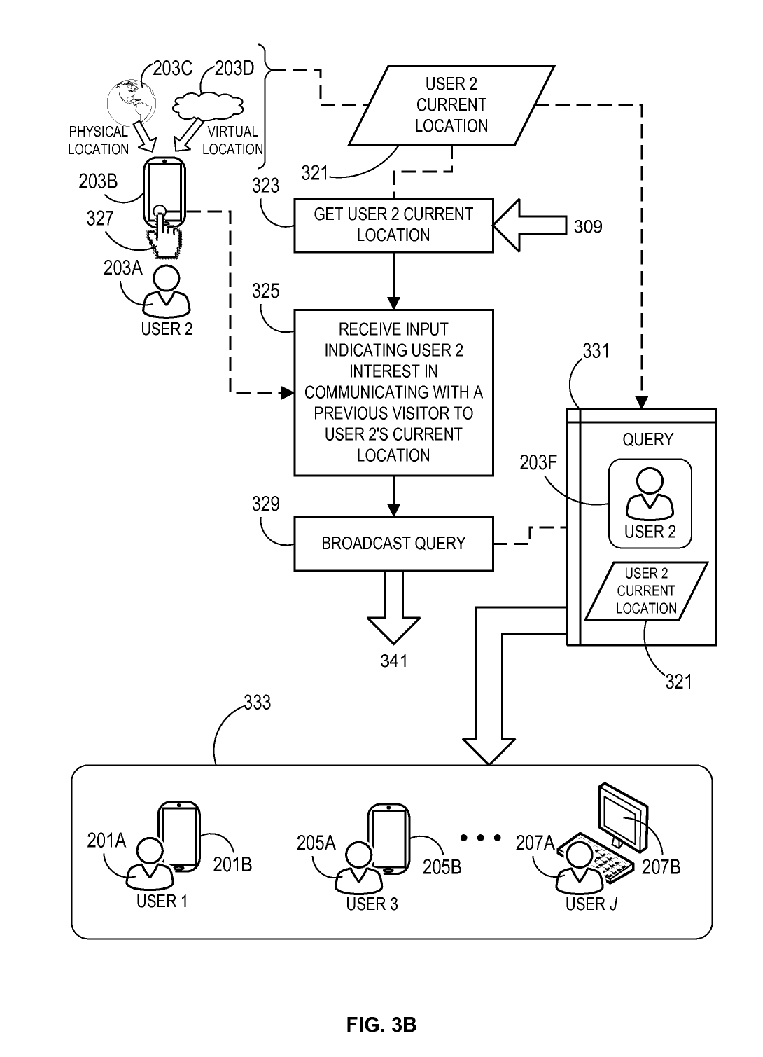

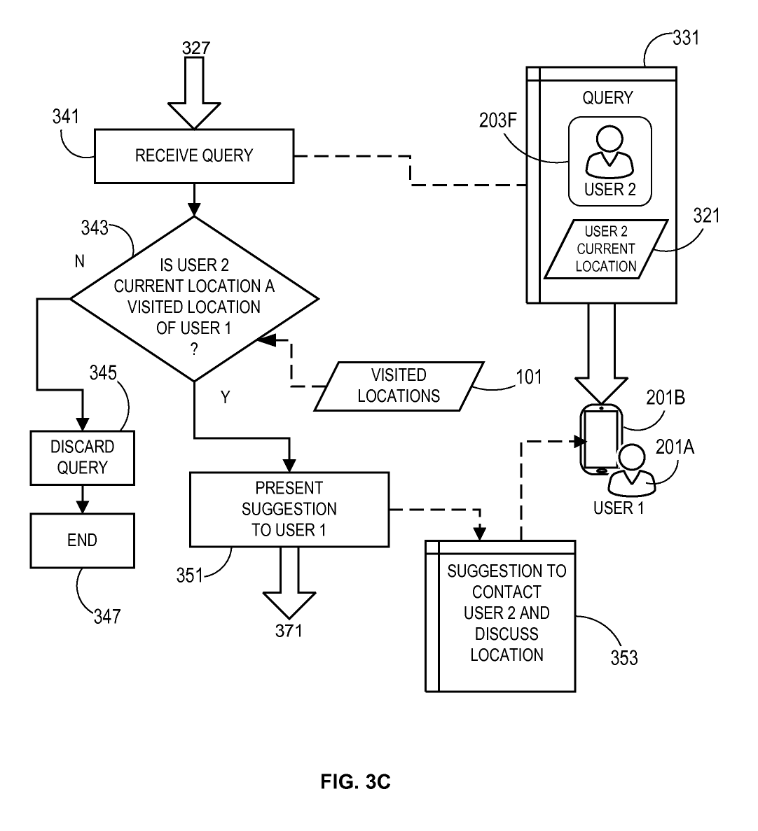

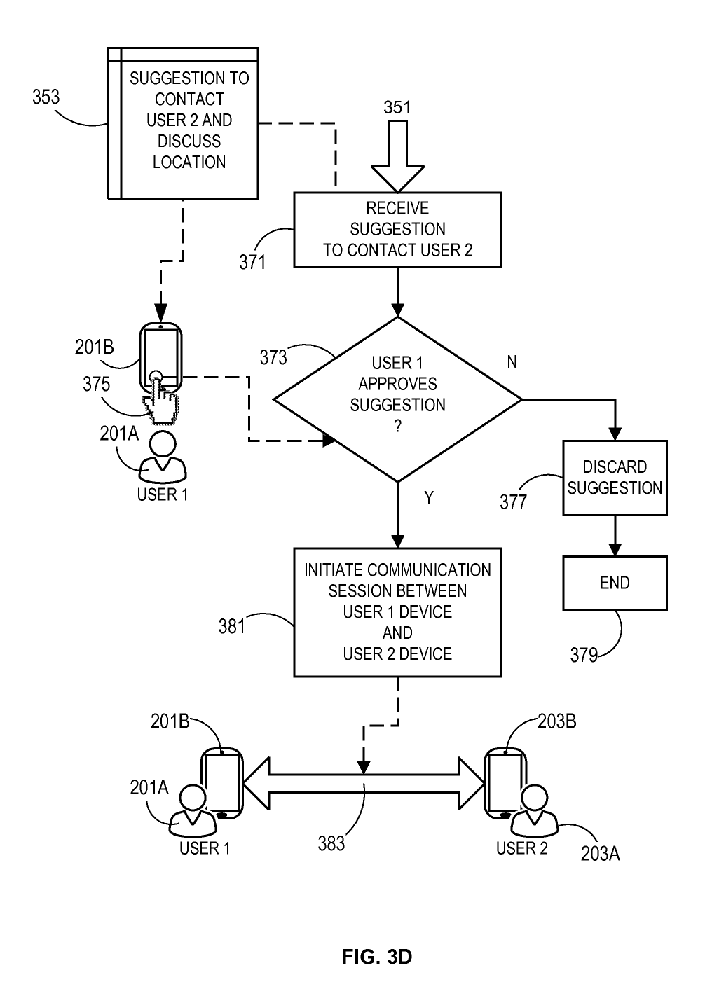

FIG. 3A is a flowchart of a portion of a method, according to an embodiment of the present invention. In a step 303, a current location 301 of first user 201A is obtained. At a decision point 305 visitation criteria 307 are used to determine if current location 301 is a visited location. (Non-limiting examples of visitation criteria for an attended location are disclosed previously.) If current location 301 is a visited location according to at least one of visitation criteria 307, then in a step 309 current location 301 is classified as a visited location, and the visit is recorded in storage, either local storage 105 and/or cloud storage 107. In a related embodiment, the recording of current location 301 as a visited location along with visit parameters is done according to the database data structures illustrated in FIG. 1A, FIG. 1B, and FIG. 1C. As indicated in FIG. 3A, step 303 is repeated as current location 301 changes. The method continues with a step 323 as illustrated in FIG. 3B.

In FIG. 3B, step 323 continues from step 309 of FIG. 3A, where a current location 321 of second user 203A is obtained. Next, in a step 325 an input 327 from second user 203A is received. Input 327 can be, in a non-limiting example, second user 203A tapping on an indicator of the screen of personal computing device 203B. Input 327 indicates that second user 203A is interested in communicating with a previous visitor to current location 321. In various embodiments of the invention, second user 203A would like to know if one of his or her existing personal contacts has visited current location 321. Then, in a step 329, a query 331 is broadcast to a group 333 of users who are existing personal contacts of second user 203A, including first user 201A. Query 331 includes an identification reference 203F to second user 203A and current location 321. Thus, all users in group 333 receive query 331 and are notified that second user 203A wants to be contacted by one or more of them who have visited location 321. Step 329 continues to a step 341 as illustrated in FIG. 3C.

It is emphasized that, according to various embodiments of the present invention, the determination that second user 203A is interested in knowing about his or her current location 321 is made solely by second user 203A. As far as the present method is concerned, second user 203A's current location not reported to any central server or other device. That is, the method according to embodiments of the present invention does not reveal to anyone but second user 203A any information or details of his or her current location 321, thereby protecting second user 203A's privacy. (It is possible that other applications, such as navigational applications, may report second user 203A's current location 321 to external entities, but such reporting is completely independent of the present method. If second user 203A wants to keep his or her current location 321 confidential, such as by disabling navigational applications and the like, the confidentiality will not be compromised by the present method.)

In FIG. 3C, step 341 continues from step 329 in FIG. 3B, where query 331 is received by first user 201A's personal computing device 201B. At a decision point 343 second user current location 321 is compared with the contents of first user 201A's visited locations data 101 (see FIG. 1A) to determine if first user 201A has previously visited second user 203A's current location 321. If first user has not previously visited location 321 according to the recorded data in visited locations data 101, then in a step 345, query 331 is discarded, and in a step 347 the method is concluded as far as first user 201A is concerned. However, if first user 201A's visited locations 101 includes a visit to second user 203A's current location 321, then in a step 351 a suggestion 353 for first user 201A to contact second user 203A for discussing current location 321 is presented to first user 201A via first personal computing device 201B. In a related embodiment of the invention, presenting the suggestion is done by a text message on the screen of personal computing device 201B. In another related embodiment, presenting the suggestion is done by an audio and/or vibrating alert by personal computing device 201B. In still another related embodiment, combinations of audio, text, video, and vibrating alerts of personal computing device 201B are used to present the suggestion to first user 201A. In a further related embodiment, details of the visit or visits, such as dates, durations, and conformity with visitation criteria are also presented to first user 201A as reminders and to refresh his or her memory concerning the visit(s). Step 351 continues to a step 371 as illustrated in FIG. 3D.

It is noted that not only does first user 201A receive query 331, but other users in group 333 also receive query 331, and the same actions shown in FIG. 3C also apply to those other users.

It is additionally emphasized that, according to various embodiments of the present invention, the determination that first user 201A previously visited second user 203A's current location 321 is performed by first user 201A's personal computing device 201B, not by a central server or other device. That is, the method according to embodiments of the present invention does not reveal to anyone but first user 201A any information or details of his or her visit(s) to location 321, thereby protecting first user 201A's privacy. (It is possible that other persons may be aware of first user 201A's visit(s) to location 321, but any knowledge they may have of the visit(s) is completely independent of the present method. If first user 201A wants to keep his or her visit(s) to location 321 confidential, the confidentiality will not be compromised by the present method.)

In FIG. 3D, step 371 continues from step 351 in FIG. 3C, where step 371 receives suggestion 353 for first user 201A to contact second user 203A to discuss location 321. At a decision point 373, an input 375 from first user 201A is used to determine the response to suggestion 353. If, for any reason, first user 201A does not approve suggestion 353 that he or she contact second user 203A to discuss location 321, then in a step 377, suggestion 353 is discarded, and in a step 379 the present method is concluded as far as first user 201A is concerned, without any information regarding first user 201A's previous visit(s) to location 321 being sent to anyone. If, however, first user 201A approves suggestion 353, then in a step 381 a communication session 383 is initiated between first user personal computing device 201B and second user personal computing device 203B so that they can discuss location 321.

According to various embodiments of the invention, communication session 383 is carried out over any suitable communication channel, including, but not limited to: voice communication, such as telephonic voice communication; text communication, such as short message service (SMS), chat, instant messaging services, electronic mail, and the like; or combinations thereof

It is noted that other users in group 333 may also have made previous visits to location 321, and if so, the same actions shown in FIG. 3D also apply to those other users.

It is furthermore emphasized that, according to various embodiments of the present invention, the decision that second user 203A receive information that current location 321 was previously visited by first user 201A is the sole choice of first user 201A, not that of a central server or any other device. That is, if first user 201A does not personally and actively approve initiating a communication session with second user 203A about current location 321, the method according to embodiments of the present invention does not reveal to second user 203A or anyone else any information or details of first user 201A's visit(s) to location 321, thereby protecting first user 201A's privacy. (Once again, it is possible that other persons may be aware of first user 201A's visit(s) to location 321, but any knowledge they may have of the visit(s) is completely independent of the present method. If first user 201A wants to keep his or her visit(s) to location 321 confidential, the confidentiality will not be compromised by the present method.)

### Notifications, Requests, and Queries

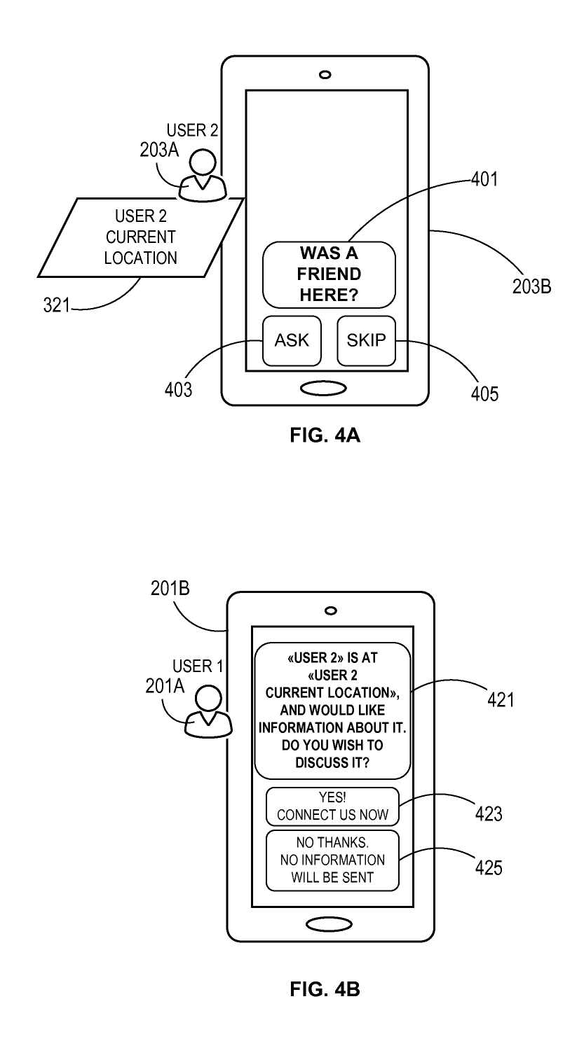

FIG. 4A illustrates a non-limiting exemplary notification and request for user input 401, according to an embodiment of the present invention. Notification and request 401 offers second user 203A the opportunity to request, from his or her contacts, information about current location 321. If second user 203A indicates a confirmation choice 403 corresponding to interest 327 (FIG. 3B), then step 325 is initiated (FIG. 3B). Alternatively, if second user 203A indicates a rejection choice 405, then no action is taken. In particular, if second user 203A chooses rejection choice 405, then no information about second user 203A's current location 321 is given out. In a related embodiment of the invention, rejection choice 405 is the default, and if no response from second user 203A is received after a predetermined amount of time, rejection choice 405 is automatically implemented.

FIG. 4B illustrates another non-limiting exemplary notification and query for user input 421, according to a related embodiment of the present invention. Notification and query 421 offers first user 201A the opportunity to respond to second user 203A's query 331 (FIG. 3C) for information concerning location 321. If first user 201A indicates an approval choice 423, then step 381 is initiated (FIG. 3D). Alternatively, if first user 201A indicates a non-approval choice 425, then no action is taken. In particular, if first user 201A chooses non-approval choice 425, then no information about first user 201A's previous visit(s) to second user 203A's current location 321 is given out. In a related embodiment of the invention, non-approval choice 425 is the default, and if no response from first user 201A is received after a predetermined amount of time, non-approval choice 425 is automatically implemented.

### Personal Computing Devices and Apps

Another embodiment of the present invention provides an application (“app”) which includes executable instructions stored in a non-transitory storage unit of a user personal computing device, which instructions, when executed by the personal computing device, cause the personal computing device to perform a method of the present invention, as previously disclosed herein.

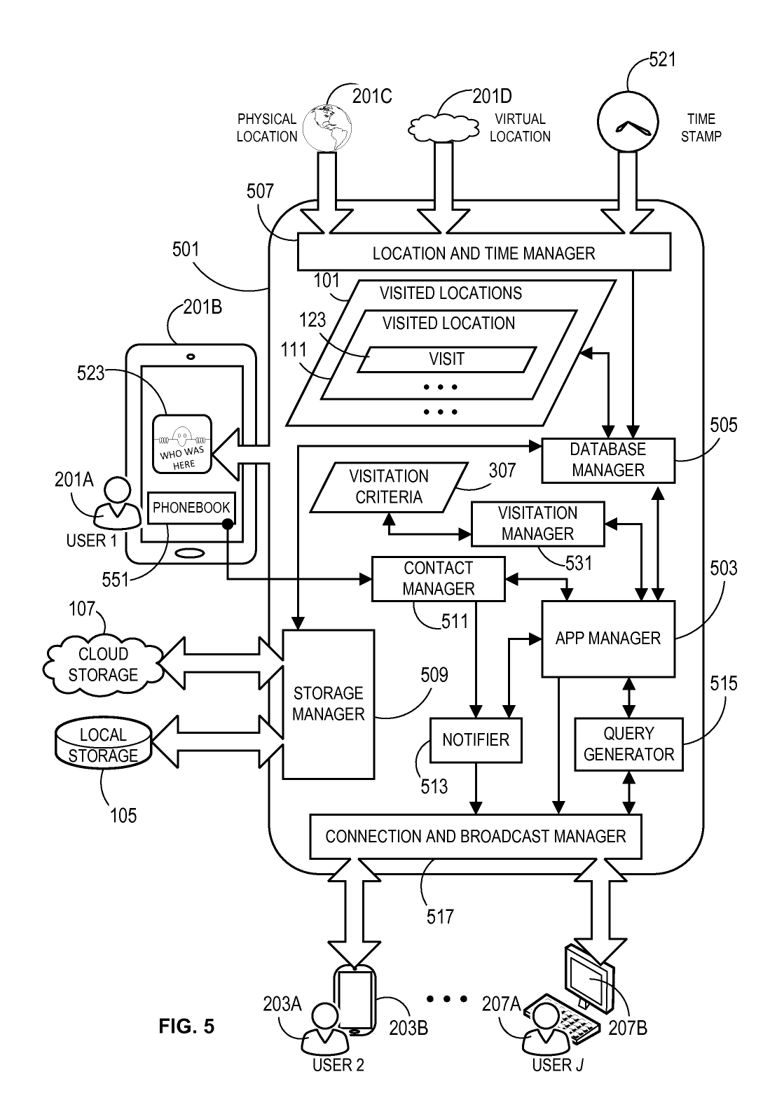

FIG. 5 is a block diagram which conceptually illustrates an application (“app”) 501 installed in first user 201A's personal computing device 201B according to an embodiment of the present invention. The executable instructions of app 501 are stored in non-transitory local storage 105 of personal computing device 201B, and an icon 523 appears on the screen thereof An app manager module 503 controls the actions of app 501 by directing, coordinating, and scheduling the operation of the various modules and data structures of app 501 to carry out the methods disclosed herein, as follows: data structures for visited locations 101, visited location 111, and visit 123 are stored in storage accessible to app 501, in local storage 105 and/or cloud storage 107 as detailed previously; a storage manager module 509 handles the storage and retrieval of database data, under control of a database manager 505, which also receives physical location information 201C and/or virtual location information 201D, along with timestamp data 521 via a location and time manager module 507.

Under control by app manager module 503, a visitation manager module 531 classifies attended locations as visited locations according to visitation criteria 307, as previously described.

App manager module 503 also directs a contact manager module 511, which has access to a phone book 551 of personal computing device 201B; a notifier module 513 for preparing user notifications, and a query generator module 515 for preparing and handling user queries and responses thereto, both of which have access to a connection and broadcast manager module 517, which app manager module 503 also controls to establish communication links with other users, such as second user 203A via second user personal computing device 203B. The term “phone book” herein denotes any facility of a personal computing device which stores and maintains data pertaining to personal contacts of the user, including but not limited to: telephone numbers of personal contacts, e-mail addresses of personal contacts, geographical addresses of personal contacts, Internet addresses of personal contacts, social network identifiers, and other data for communicating with personal contacts.

The terms “manager” and “module” herein denote any set of executable instructions which provides a particular functionality or group of functionalities to app 501, whether or not explicitly identified as a separate unit of executable code. Manager modules are shown conceptually in FIG. 5 for purposes of illustration and description.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A method for leaving social traces by personal computing devices, the method comprising:
storing in a data storage, by a first personal computing device, a plurality of stored locations, wherein each stored location is stored upon being a current location of the first personal computing device;
receiving, in the first personal computing device, a query from a second personal computing device of a second user, the query identifying at least the second user and a queried location;
responsively to the receiving the query: recognizing, by the first personal computing device, the queried location as being the same as one of the plurality of stored locations;
responsively to the recognizing: presenting to the first user, by the first personal computing device, a suggestion to communicate with the second user regarding the queried location; and
responsively to receiving a user approval of the suggestion: initiating, by the first personal computing device, a communication session between the first personal computing device and the second personal computing device.

2. The method of claim 1, wherein the storing is of a current location that is automatically classified, by the first personal computing device, as visited location according to at least one predetermined visitation criterion.

3. The method of claim 2, wherein one of the at least one visitation criterion is that the first personal computing device has remained at the current location for at least a predetermined positive period of time.

4. The method of claim 2, wherein one of the at least one visitation criterion is that the first personal computing device has taken at least a predetermined positive number of photographs or videos or screenshots at the current location.

5. The method of claim 2, wherein one of the at least one visitation criterion is that the first personal computing device has been used for spending at least a predetermined positive amount of money at the current location.

6. The method of claim 2, wherein one of the at least one visitation criterion is that the first personal computing device has been used for purchasing at least a predetermined positive number of items at the current location.

7. The method of claim 1, wherein the data storage is part of the first personal computing device.

8. The method of claim 1, wherein the data storage is a cloud storage of the first user.

9. The method of claim 1, wherein the first personal computing device and the second personal computing device are mobile devices, and wherein the queried location and at least one stored location are physical locations.

10. The method of claim 1, wherein the queried location and at least one stored location are virtual locations accessible via a network.

11. The method of claim 10, wherein at least one of the first personal computing device or the second personal computing device is a mobile device.

12. The method of claim 10, wherein at least one of the first personal computing device or the second personal computing device is a stationary device.

13. A personal computing device for a user, the personal computing device comprising:
a processor;
a user interface; and
a non-transitory storage containing a set of executable instructions for the processor, wherein the executable instructions, when executed by the processor, cause the personal computing device to perform:
storing in a data storage a plurality of stored locations, wherein each stored location is stored upon being a current location of the personal computing device;
receiving, in the personal computing device, a query from a different personal computing device of a different user, the query identifying at least the different user and a queried location;
responsively to the receiving the query: recognizing, by the personal computing device, the queried location as being the same as one of the plurality of stored locations;
responsively to the recognizing: presenting to the user, via the user interface, a suggestion to communicate with the different user regarding the queried location; and
responsively to receiving a user approval of the suggestion: initiating, by the personal computing device, a communication session between the personal computing device and the different personal computing device.

14. The personal computing device of claim 13, further comprising additional executable instructions in the non-transitory storage, wherein the additional executable instructions, when executed by the processor, cause the personal computing device to perform:
classifying a location as a visited location, wherein the classifying is automatically made according to at least one predetermined visitation criterion, and wherein the storing is of a current location that is automatically thereby classified as a visited location.

15. The personal computing device of claim 14, wherein one of the at least one visitation criterion is that the personal computing device has remained at the current location for at least a predetermined positive period of time.

16. The personal computing device of claim 14, wherein one of the at least one visitation criterion is that the personal computing device has taken at least a predetermined positive number of photographs or videos or screenshots at the current location.

17. The personal computing device of claim 14, wherein one of the at least one visitation criterion is that the personal computing device has been used for spending at least a predetermined positive amount of money at the current location.

18. The personal computing device of claim 14, wherein one of the at least one visitation criterion is that the personal computing device has been used for purchasing at least a predetermined positive number of items at the current location.

19. The personal computing device of claim 13, wherein the data storage is part of the personal computing device.

20. The personal computing device of claim 13, wherein the data storage is a cloud storage of the user.

21. An app comprising a set of executable instructions in a non-transitory storage, wherein the executable instructions of the app, when executed by a processor of a personal computing device of a user, cause the personal computing device to perform:
storing in a data storage a plurality of stored locations, wherein each stored location is stored upon being a current location of the personal computing device;
receiving, in the personal computing device, a query from a different personal computing device of a different user, the query identifying at least the different user and a queried location;
responsively to the receiving the query: recognizing, by the personal computing device, the queried location as being the same as one of the plurality of stored locations;
responsively to the recognizing: presenting to the user, via the user interface, a suggestion to communicate with the different user regarding the queried location; and
responsively to receiving a user approval of the suggestion: initiating, by the personal computing device, a communication session between the personal computing device and the different personal computing device.

22. The app of claim 21, further comprising additional executable instructions in the non-transitory storage, wherein the additional executable instructions, when executed by the processor, cause the personal computing device to perform:
classifying a location as a visited location, wherein the classifying is automatically made according to at least one predetermined visitation criterion, and wherein the recording is only of a current location that is automatically thereby classified as a visited location.

23. The app of claim 22, wherein one of the at least one visitation criterion is that the personal computing device has remained at least a predetermined positive period of time at the current location.

24. The app of claim 22, wherein one of the at least one visitation criterion is that the personal computing device has taken at least a predetermined positive number of photographs or videos or screenshots at the current location.

25. The app of claim 22, wherein one of the at least one visitation criterion is that the personal computing device has been used for spending at least a predetermined positive amount of money at the current location.

26. The app of claim 22, wherein one of the at least one visitation criterion is that the personal computing device has been used for purchasing at least a predetermined positive number of items at the current location

27. The app of claim 21, wherein the data storage is part of the personal computing device.

28. The app of claim 21, wherein the data storage is a cloud storage of the user.
